(19) United States
(12) Patent Application Publication
(10) Pub. No.: US 2026/0019390 A1
(43) Pub. Date: Jan. 15, 2026

(54) METHOD, APPARATUS, DEVICE AND STORAGE MEDIUM FOR INFORMATION PROCESSING

(71) Applicants: Beijing Zitiao Network Technology Co., Ltd., Beijing (CN); Lemon Inc., Grand Cayman (KY)

(72) Inventors: Xin XIE, Singapore (SG); Junyuan QI, Beijing (CN); Yibing ZHU, Los Angeles, CA (US); Yang LIU, Beijing (CN); Bowen ZHAO, Beijing (CN); Yiguo WANG, Beijing (CN); Yingyi XU, Beijing (CN); Tianzi YUAN, Los Angeles, CA (US); Koken ISHII, Los Angeles, CA (US); Yingdi SUN, Beijing (CN)

(21) Appl. No.: 19/334,786

(22) Filed: Sep. 19, 2025

Related U.S. Application Data
(63) Continuation of application No. PCT/CN2024/087337, filed on Apr. 11, 2024.

(30) Foreign Application Priority Data
Apr. 11, 2023 (CN) 202310382497.7
May 12, 2023 (CN) 202310540084.7

(51) Int. Cl. H04L 51/02; G06F 21/60

(52) U.S. Cl. CPC H04L 51/02; G06F 21/604

(57) ABSTRACT

The embodiments of the disclosure provide a method, an apparatus, a device and a storage medium for information processing. The method includes presenting an option associated with a digital assistant that is a contact of a user and uniquely corresponds to the user. The method further includes in response to a selection of the option, presenting a chat window for the user and the digital assistant. The method further includes presenting, in the chat window, a chat message between the user and the digital assistant.

### CROSS-REFERENCE TO RELATED APPLICATION(S)

This application is a continuation of International Patent Application No. PCT/CN2024/087337, filed on Apr. 11, 2024, which claims the benefit of Chinese Patent Application No. 202310382497.7, filed on Apr. 11, 2023, entitled “Method, Apparatus, Device, and Storage Medium for Information Processing,” and this application further claims the benefit of Chinese Patent Application No. 202310540084.7 filed on May 12, 2023 entitled “Method, Apparatus, Device and Storage Medium for Information Processing,” which are hereby incorporated by reference in their entireties.

### FIELD

Example embodiments of the present disclosure generally relate to the field of computers, and in particular, to a method, an apparatus, a device, and a computer readable storage medium for information processing.

### BACKGROUND

With the development of information technologies, various terminal devices may provide various services to people in aspects such as work and life. For example, a service providing component may be deployed in the terminal device. The terminal device or its component may provide an assistant-type function to the user to assist the user in using the terminal device or component. How to implement such an assistant-type function to better serve users is a technical problem currently being explored.

### SUMMARY

In a first aspect of the present disclosure, a method of information processing is provided. The method includes: presenting an option associated with a digital assistant that is a contact of a user and uniquely corresponds to the user; in response to a selection of the option, presenting a chat window for the user and the digital assistant; and presenting, in the chat window, a chat message between the user and the digital assistant.

In a second aspect of the present disclosure, a method of information processing is provided. The method includes: presenting a profile interface with a profile of a digital assistant displayed, the digital assistant uniquely corresponding to a user; and in response to an input operation on the profile interface, updating at least a portion of the profile.

In a third aspect of the present disclosure, an apparatus for information processing is provided. The apparatus includes: an option presenting module configured to present an option associated with a digital assistant that is a contact of a user and uniquely corresponds to the user; a chat window presenting module configured to in response to a selection of the option, present a chat window for the user and the digital assistant; and a chat message presenting module configured to present, in the chat window, a chat message between the user and the digital assistant.

In a fourth aspect of the present disclosure, an apparatus for information processing is provided. The apparatus includes: a profile interface presenting module configured to present a profile interface with a profile of a digital assistant displayed, the digital assistant uniquely corresponding to a user; and a profile updating module configured to in response to an input operation on the profile interface, updating at least a portion of the profile.

In a fifth aspect of the present disclosure, an electronic device is provided. The electronic device includes at least one processor; and at least one memory coupled to the at least one processor and storing instructions for execution by the at least one processor. The instructions, when executed by the at least one processor, cause the electronic device to perform the method of the first aspect or the second aspect.

In a sixth aspect of the present disclosure, a computer readable storage medium is provided. The computer readable storage medium stores a computer program, and the computer program is executable by the processor to implement the method of the first aspect or the second aspect.

It should be understood that the content described in this content section is not intended to limit the key features or important features of the embodiments of the present disclosure, nor is it intended to limit the scope of the present disclosure. Other features of the present disclosure will become easily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure can be implemented;

FIGS. 2A and 2B illustrate schematic diagrams of example contact interfaces according to some embodiments of the present disclosure;

FIG. 2C illustrates a schematic diagram of an example profile interface of a digital assistant according to some embodiments of the present disclosure;

FIGS. 3A and 3B illustrate schematic diagrams of example profile interfaces according to some embodiments of the present disclosure;

FIG. 3C illustrates a schematic diagram of an example permission setting interface according to some embodiments of the present disclosure;

FIGS. 4A to 4C illustrate schematic diagrams of example chat windows according to some embodiments of the present disclosure;

FIGS. 5A to 5C illustrate schematic diagrams of example reply messages according to some embodiments of the present disclosure;

FIG. 6 illustrates a schematic diagram of a chat message including a multi-round dialogue according to some embodiments of the present disclosure;

FIGS. 7A to 7C illustrate schematic diagrams of example chat windows that start a new topic according to some embodiments of the present disclosure;

FIGS. 8A to 8C illustrate schematic diagrams of example chat windows that stop and restart replies, according to some embodiments of the present disclosure;

FIGS. 9A to 9C illustrate schematic diagrams of example chat windows for a user to further input messages according to some embodiments of the present disclosure;

FIG. 10 illustrates a flowchart of a process of information processing according to some embodiments of the present disclosure;

FIG. 11 illustrates a flowchart of a process of information processing according to some embodiments of the present disclosure;

FIG. 12 illustrates a flowchart of a process of information processing according to some embodiments of the present disclosure;

FIG. 13 illustrates a block diagram of an apparatus for information processing according to some embodiments of the present disclosure;

FIG. 14 illustrates a block diagram of an apparatus for information processing according to some embodiments of the present disclosure;

FIG. 15 illustrates a block diagram of an apparatus for information processing according to some embodiments of the present disclosure; and

FIG. 16 illustrates a block diagram of a device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be interpreted as limited to the embodiments described herein, but rather, these embodiments are provided for a more thorough and complete understanding of the present disclosure. It should be understood that the drawings and embodiments of the present disclosure are for illustrative purposes only and are not intended to limit the scope of the present disclosure.

In the description of the embodiments of the present disclosure, the terms “including” and the like should be understood to as open-ended terms, i.e., “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may further be included below.

Herein, unless explicitly stated, “in response to A” performs a step and does not imply that this step is performed immediately after “A”, but may include one or more intermediate steps.

It may be understood that the data involved in the technical solution (including but not limited to the data itself, the obtaining, using, storing or deleting of the data) should follow the requirements of the corresponding laws, regulations and related provisions.

It can be understood that before using the technical solutions disclosed in the embodiments of the present disclosure, relevant users should be informed of the types, use scope, usage scenarios, and the like of the information related to the present disclosure in an appropriate manner according to relevant laws and regulations, and the authorization of the relevant users should be obtained, wherein the relevant users may include any type of rights body, such as individuals, cooperates, and groups.

For example, in response to receiving an active request from a user, prompt information is sent to the relevant user to explicitly prompt the relevant user, and the operation requested to be performed will need to obtain and use the information of the relevant user, so that the relevant user can autonomously select whether to provide information to software or hardware such as electronic device, application, servers or storage media for executing the operation of the technical solution of the present disclosure according to the prompt information.

As an optional but non-limiting implementation, in response to receiving the active request from the relevant user, a manner of sending prompt information to the relevant user may be, for example, a pop-up window, and prompt information may be presented in text in the pop-up window. In addition, the pop-up window may further carry a selection control for the user to select “agree” or “disagree” to provide information to the electronic device.

It may be understood that the foregoing notification and obtaining the authorization of the user process are merely illustrative, and do not constitute a limitation on implementations of the present disclosure, and other manners of meeting relevant laws and regulations may further be applied to implementations of the present disclosure.

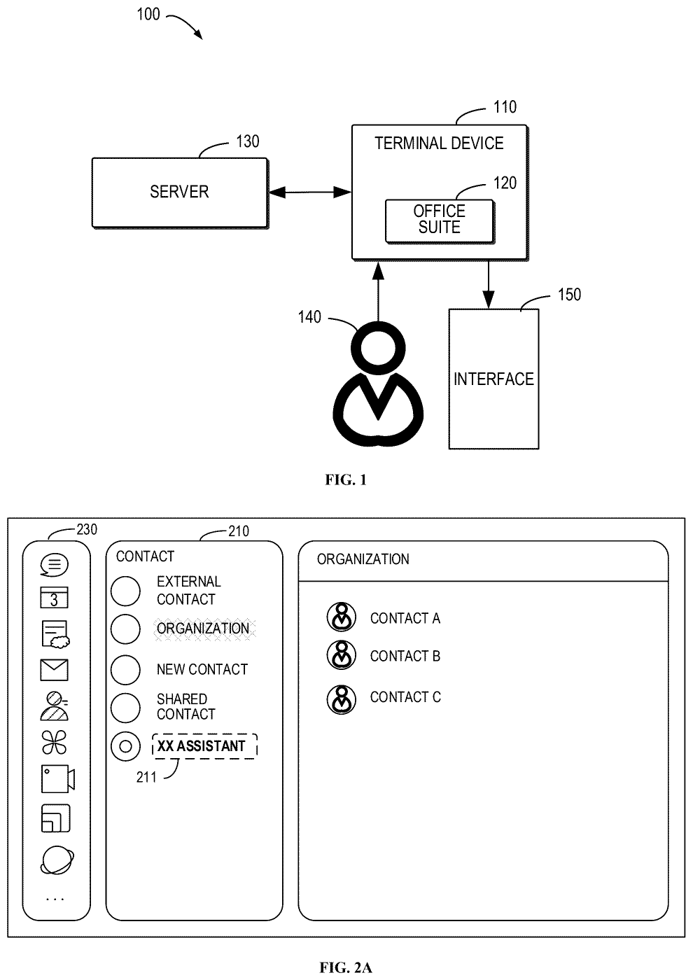

FIG. 1 illustrates a schematic diagram of an example environment 100 in which embodiments of the present disclosure can be implemented. In this example environment 100, an office suite 120 is installed in the terminal device 110. The user 140 may interact with the office suite 120 via the terminal device 110 and/or an attachment device of the terminal device 110. The office suite 120 can provide integration of multiple components to the user 140. These components may serve as component modules in the office suite 120. Components integrated in the office suite 120 are sometimes referred to as “office applications”, “office components”, “collaborative office platforms”, and the like. As an example, components integrated in the office suite 120 may include, but are not limited to, one or more of: a chat component (further referred to as an instant messaging (IM) component), a document component, an audio-video conference component, a mail component, a calendar component, a schedule component, a task component, an objective and key results (OKR) component.

In some embodiments, the office suite 120 may be downloaded as an application, installed on the terminal device 110. In some embodiments, the office suite 120 may also be accessed in other manners, such as be accessed via web pages.

In the environment 100 of FIG. 1, if the office suite 120 is launched, the terminal device 110 may present an interface 150 of the office suite 120 to the user 140. The interface 150 is sometimes referred to as a client interface. The interface 150 may include various kinds of interfaces that can be provided by the office suite 120, such as a chat interface presenting chat content, a video conference interface, a file sharing interface, and the like.

In some embodiments, the terminal device 110 communicates with the server 130 to enable provision of services to office suite 120. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a television receiver, a radio broadcast receiver, an electronic book device, a gaming device, or any combination of the foregoing, including accessories and peripherals of these devices, or any combination thereof. In some embodiments, the terminal device 110 can further support any type of interface for a user (such as a “wearable” circuit, etc.). The server 130 may be various types of computing systems/servers capable of providing computing capabilities, including, but not limited to, mainframes, edge computing nodes, computing devices in a cloud environment, and the like.

It should be understood that the structures and functions of the various elements in the environment 100 are described for example purposes only and do not imply any limitation to the scope of the present disclosure.

As briefly mentioned above, a digital assistant may be provided to the user to assist the user in using the terminal device or the application. On the other hand, with the continuous development of machine learning, it is also expected to utilize machine learning to bring new experiences to users, such as bringing new experiences to users in office applications. Some existing solutions are capable of utilizing digital assistants to help the users create content, generate presentations, organize mailboxes, extract to-do items, and the like. However, in these solutions, an interaction mode between the users and the digital assistant is not flexible enough and easy to use.

The embodiment of the present disclosure provides a scheme for information processing. According to various embodiments of the present disclosure, the digital assistant corresponding to the user may interact with the user as a contact of the user. In this interaction mode, the user may initiate a chat with the digital assistant through an option associated with the digital assistant. For another example, if the digital assistant is implemented in an office suite application including multiple applications, the digital assistant may be invoked in a predetermined manner corresponding to any application. As another example, the user may modify the profile of the digital assistant. Therefore, the flexibility and ease of use of the digital assistant are improved. This is beneficial in bringing an efficient assistant experience to the user.

Some example embodiments of the present disclosure will be described below with reference to the accompanying drawings. In the following, a chat application (for example, a chat component in an office suite) is mainly described as an example scenario, but this is merely an example and is not intended to limit the scope of the present disclosure. The digital assistant may be implemented in any suitable application, application set, or device.

The digital assistant of the user 140 may interact with the user 140 as a contact of the user 140. Such a digital assistant may uniquely correspond to user 140. In other words, the digital assistant of the user 140 may be specific or exclusive to the user 140. For example, in a process in which the digital assistant provides assistance or service for the user 140, the digital assistant may utilize its historical interaction information with the user 140, data of the user 140 that it is capable of accessing, its current chat content with the user, etc. If the user 140 is an individual or a person, such a digital assistant may be considered a personal digital assistant. It will be appreciated that, in the disclosed embodiment, the digital assistant is based on data for which access is granted through authorization of the user 140.

It should be understood that the “uniquely correspond” or the like in the present disclosure is not intended to limit that the digital assistant will be updated accordingly based on the interaction process between the user 140 and the digital assistant.

In some embodiments, the information handling service specific to the user 140 can be provided based on historical interaction information between the user 140 and the digital assistant and/or a data range specific to the user 140. Therefore, a degree of freedom of interaction between the user 140 and the digital assistant can be improved.

For example, when a user interacts with a traditional assistant, a user usually needs to clearly and explicitly express information processing requirements according to a certain requirement. In contrast, by considering historical interaction information and/or the data range specific to the user, embodiments of the present disclosure can support the user to express the information processing requirement in a freer and simpler manner without affecting the quality of the obtained information processing service.

In addition, the manner can improve the information processing accuracy of the digital assistant. According to such an example implementation, the present disclosure may establish a “unique correspondence” between the user 140 and the digital assistant.

In some embodiments, the digital assistant may be implemented in a single component or application, such as an IM application. In some embodiments, the digital assistant may be implemented in multiple components. For example, these components may be different components of an office suite or a collaborative office platform. In some embodiments, the digital assistant may be implemented directly in the terminal device 110 without depending on any application. In such embodiments, the digital assistant provides assistance to the user 140 in the form of a contact.

In some embodiments, if the digital assistant is specific or exclusive to the user 140, the digital assistant may be configured to respond to the input message of the user 140 or perform operations related to the input message based on the followings: the historical interaction information between the user 140 and the digital assistant in the plurality of components, the data range that the digital assistant is permitted to access, and the input message of the user 140. In this way, more accurate and user-expected answers can be provided to the user.

In some embodiments, the historical interaction information between the user 140 and the digital assistant in the plurality of components is stored in association with the user 140. For example, the historical interaction information in the different components may be stored in association with the user 140 by uniformly adopting the same identifier or a storage manner. That is, full scenario consistency is achieved. This can meet the digital assistant usage of the user in full scenarios such as IM, documents, calendars, meetings, and the like, and the interaction in full scenarios are standardized and unified.

In some embodiments, if the digital assistant is implemented in an office suite including a plurality of components, the interaction information between the user 140 and the digital assistant across different components may be uniformly associated with the user 140 for storage. For example, at least one chat message of the user 140 with the digital assistant in the first component of the office suite may be obtained, a chat window between the user 140 and the digital assistant is presented in the second component of the office suite, and at least a portion of the at least one chat message is displayed in the chat window. In some embodiments, the second component may be a chat component of an office suite. In some embodiments, the chat window displays an aggregated message corresponding to the at least one chat message. In some embodiments, a selection of the aggregated message may further be received and the entire content of the at least one chat message may be presented.

The user 140 may invoke the digital assistant in various suitable ways to interact therewith. In some embodiments, if the digital assistant is implemented in an office suite that includes multiple components, the digital assistant may be invoked through any of the components. In each component, the digital assistant may be invoked through a predetermined manner corresponding to the component to receive instructions input by the user 140. The predetermined manner corresponding to a component may depend on a type and characteristics of the component. The embodiments of the present disclosure are not limited in this regard.

In some embodiments, the terminal device 110 may present a option related to the digital assistant. If the user 140 selects the option (e.g., clicks on the option), the digital assistant is invoked. Accordingly, the terminal device 110 presents the chat window between the user 140 and the digital assistant, and presents the chat message between the user 140 and the digital assistant in the chat window.

In some embodiments, the digital assistant may be invoked in a search manner to interact therewith. For example, the user 140 may input keywords related to the digital assistant (such as the name of the digital assistant, a remark name) in the search box of the application. In response, the option related to the digital assistant may be presented as a search result. The user 140 may initiate a chat window with the digital assistant by clicking on the option.

In some embodiments, the digital assistant may be invoked through a contact list or an address book. For example, a contact option corresponding to the digital assistant may be presented in a contact interface. In this way, a stable entry for the digital assistant may be provided to facilitate the user 140 to conveniently invoke the digital assistant when needed.

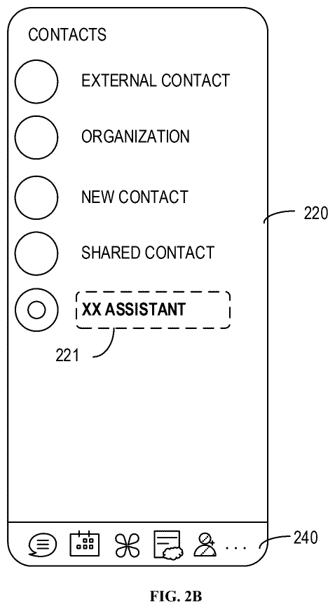

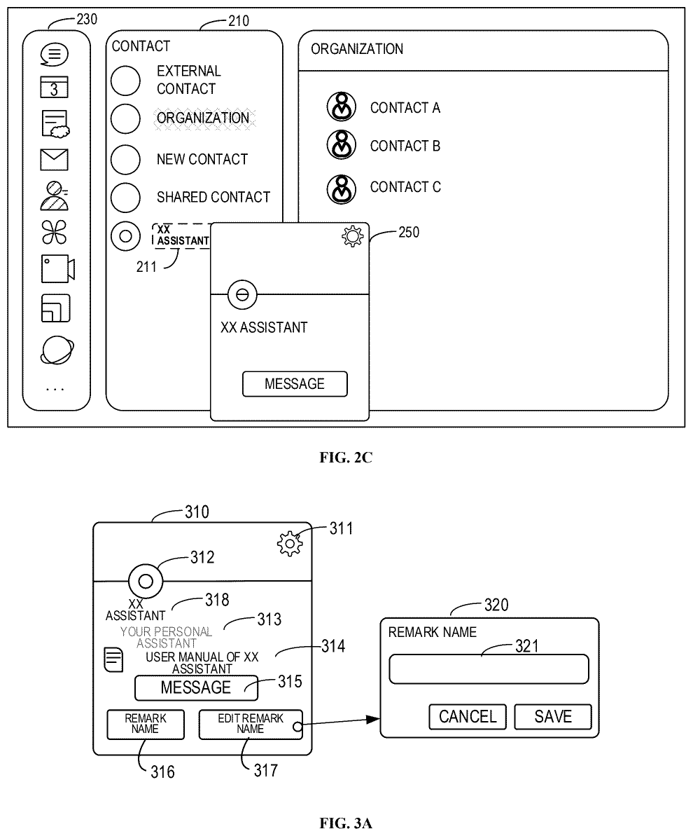

FIGS. 2A and 2B respectively illustrate example contact interfaces according to some embodiments of the present disclosure. The interfaces shown in FIGS. 2A and 2B may be considered as example implementations on different types of devices. As shown in FIG. 2A, an icon interface 230 displays an access icon of a plurality of components, through which the corresponding components may be launched to operate by selecting the icons.

In this example, the address book is selected, thereby presenting the contact interface 210. A contact option 211 corresponding to the digital assistant is displayed in the contact interface 210. Similarly, as shown in FIG. 2B, the icon interface 240 displays access icons for a plurality of applications. A contact option 221 corresponding to the digital assistant is displayed in the contact interface 220. In these two examples and the examples below, the digital assistant is shown with a name of “xx assistant”, but it should be understood that this is only for the purpose of illustration and not intended to limit the scope of the present disclosure. In the embodiments of the present disclosure, the digital assistant may have any suitable name. By clicking on the contact option, the user 140 may invoke the digital assistant and interacting therewith.

In some embodiments, the digital assistant as a contact may have a profile, which is further referred to as configuration information of the digital assistant. The profile may include, but is not limited to, an avatar representing the digital assistant, a name for remarking the digital assistant (also referred to as a remark name), description information for the digital assistant (e.g., signature, etc.). In some embodiments, the profile may further include explanation information for the digital assistant, such as a manual, a help manual and the like of the digital assistant.

In some embodiments, the user 140 may view and modify the profile of the digital assistant. For example, the terminal device 110 may present a profile interface displaying the profile of the digital assistant. The presentation of the profile interface may be triggered in any suitable manner. For example, if user 140 clicks on the avatar of the digital assistant in the contact interface or a contact list, the profile interface may be presented.

As shown in FIG. 2C, the user clicks on the avatar representing the digital assistant in the contact interface 210, and accordingly the profile interface 250 is presented. As another example, if the user 140 clicks on the avatar representing the digital assistant in the chat window with the digital assistant, the profile interface may be presented.

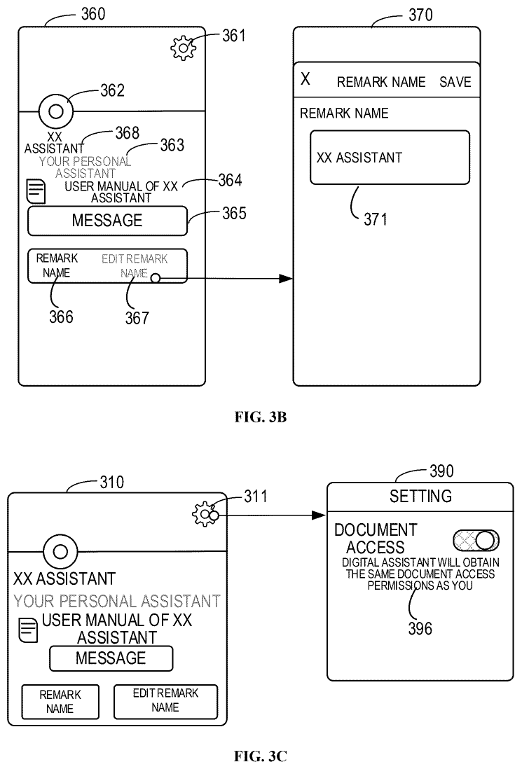

At least a portion of the profile of the digital assistant may be displayed in the profile interface. FIGS. 3A and 3B illustrate a profile interface 310 and a profile interface 360, respectively, that may be viewed as example implementations of a profile interface on different types of devices, according to some embodiments of the present disclosure. In profile interface 310, there is shown avatar 312 representing the digital assistant, the name 318 of the digital assistant (“xx assistant” in this example), the description information 313 for the digital assistant, and the remark name 316 of the digital assistant (“Remark Name” in the example). In profile interface 360, there is shown avatar 362 representing the digital assistant, the name 368 of the digital assistant (“xx assistant” in this example), the description information 363 for the digital assistant, and the remark name 366 of the digital assistant (“Remark Name” in the example).

The profile interface may further include interactive elements, such as a help link, a settings control, a message control, and the like. In some embodiments, the profile interface may display a link of the explanation information of the digital assistant. If a trigger is detected on a link in the profile interface, the explanation information for the digital assistant may be presented. For example, if the link 314 in the profile interface 310 or the link 364 in the profile interface 360 is clicked, the user manual of the xx assistant may be displayed.

In some embodiments, a message control for initiating a chat with the digital assistant may be presented in the profile interface. If a trigger on the message control is detected, the chat window between the user and the digital assistant may be presented. For example, if the user clicks on the message control 315 in the profile interface 310 or the message control 365 in the profile interface 360, the chat interface between the user and the digital assistant may be displayed.

In some embodiments, if an input operation to the profile interface is detected, at least a portion of the profile may be updated. The user 140 may modify one or more of the avatars representing the digital assistant, the remark name, and the description information. For example, the user 140 may change the avatar of the digital assistant by clicking on the avatar.

An edit control 317 for modifying the remark name of the digital assistant is displayed in the profile interface 310. In response to a trigger on the editing control 317 (e.g., being clicked), a remark name setting interface 320 may be presented. The user 140 may input a new remark name for the digital assistant in the block 321. Similarly, an edit control 367 for modifying the remark name of the digital assistant is displayed in the profile interface 360. In response to a triggering on the editing control 367 (e.g., being clicked), a remark setting interface 370 may be presented. The user 140 may input a new remark name for the digital assistant in the block 371.

By allowing the user to modify the profile of the digital assistant, the user can customize aspects such as the name, an appearance, a style and the like of the digital assistant, which is beneficial to improving the user experience.

In some embodiments, the user 140 may set the data range that the digital assistant is permitted to access.

If the digital assistant is exclusive to the user 140, the data range of the user 140 that the digital assistant is permitted to access may be set. For example, it may be set which one or more of documents, calendars, mailboxes and the like of the user are permitted to be ready by the digital assistant. Furthermore, it may be set which documents, which dates of the calendars, or which subjects of the emails are permitted to be read.

A setting controls for setting the data range may be presented, such as the setting controls 311 and 361 shown in FIG. 3A and FIG. 3B. If a trigger on the setting control is detected, a permission setting interface associated with the profile for the digital assistant may be presented. The user 140 may set the data range that the digital assistant is permitted to access via the permission settings interface.

An example is described with reference to FIG. 3C. A trigger is detected for settings control 311 in profile interface 310, for example the user clicks on the settings control 311. In response, the permission setting interface 390 is presented. By ways of example only, in the interface, the document access permission of the user may be turned on and off. The permission setting interface 390 further displays prompt information 396 regarding the digital assistant permission.

In some embodiments, for an incremental user, the digital assistant of the user may be created in response to a creation of a user account. For an existing user, after a launch of the digital assistant function, the digital assistant may be created for the user. In some embodiments, a query may be presented to the user asking whether to create the digital assistant. In response to receiving a confirmation reply from the user, the digital assistant is created for the user.

As mentioned above, by triggering the option related to the digital assistant, the chat window between the user 140 and the digital assistant may be presented. For example, the user 140 clicks the contact option corresponding to the digital assistant in contact interface or click on the message control in the profile interface to trigger the presentation of the chat window. Through the chat window, an input message from user 140 may be received indicating the operation expected to be completed by the digital assistant. The digital assistant may then process the input message of user 140 and generate a reply message for the input message. Accordingly, a reply message output by the digital assistant may be presented in the chat window.

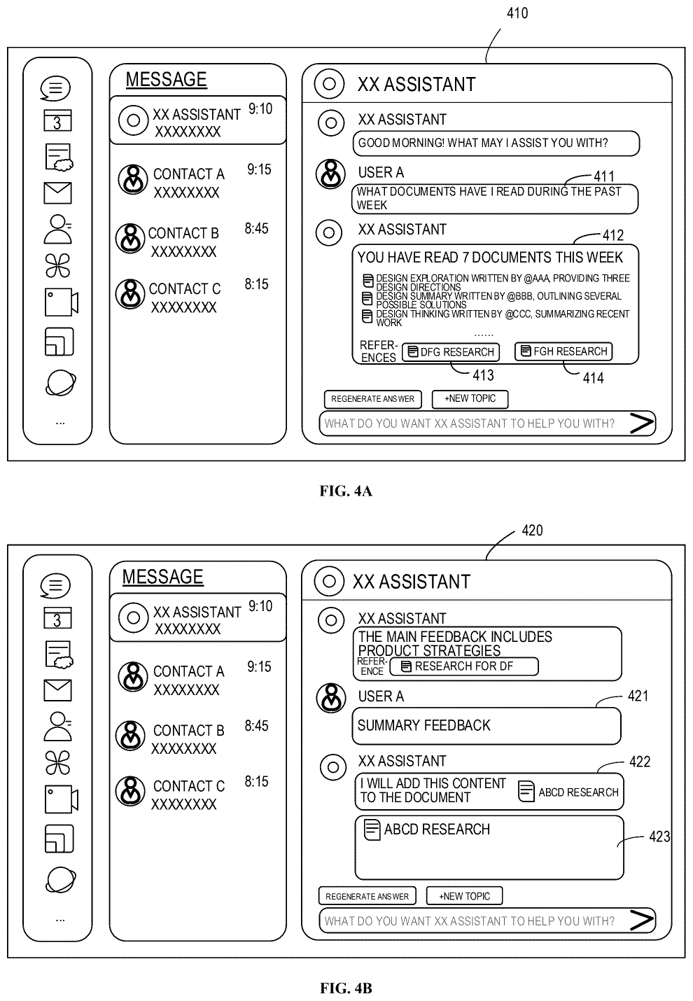

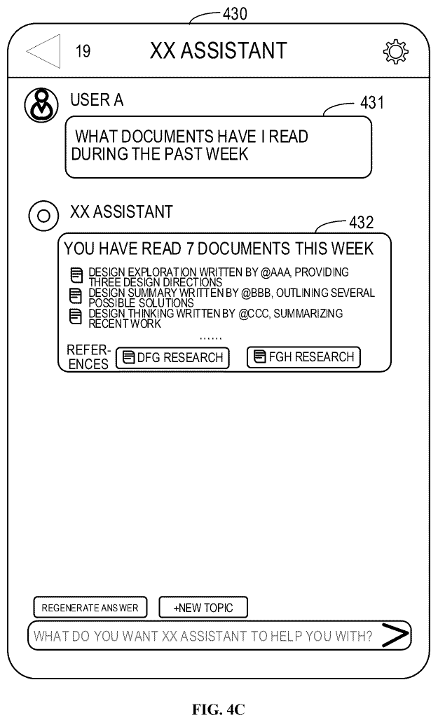

FIG. 4A to FIG. 4C illustrate example chat windows 410, 420, and 430, respectively, according to some embodiments of the present disclosure. In the chat window 410, an input message 411 of the current user (“User A”) and a corresponding reply message 412 are displayed. In the chat window 420, an input message 421 of the current user and corresponding reply messages 422 and 423 are displayed. Similarly, in the chat window 430, an input message 431 of the current user and a corresponding reply message 432 are displayed.

The reply of the digital assistant needs select an appropriate language to facilitate an understanding by the user 140. In some embodiments, the language of the reply message may be determined based on at least one of the following: the language specified by the user 140, the language of the message input by the user 140, the language of the content referenced by the reply message output by the digital assistant, or a system language of the component presenting the chat window. The language specified by the user may be the language explicitly requested in the user instruction. For example, the input message of the user 140 may be “Please reply in Chinese”.

The language of the message input by the user 140 may be the language of the user instruction itself. The language of the content referenced the reply message output by the digital assistance may refer to the language of the content itself, e.g., the language of one or more documents used by the digital assistant in a process of generating the reply. The system language of the components presenting the chat window may be the system language of the component or an office suite in which the digital assistant is implemented. In this way, self-adaptation of the language of the reply of the digital assistant reply may be realized.

In some embodiments, if a conflict occurs among the language mentioned above, the language of the reply message may be determined based on a priority order. As an example, the priority order of the above from high to low may be as follows: the language specified by the user 140, the language of the message input by the user 140, the language of the content referenced by the reply message output by the digital assistant, or the system language of the component presenting the chat window. It should be understood, however, that the priority order provided herein is only for the purpose of illustration and is not intended to limit the scope of the present disclosure.

The reply message may include interactive elements (e.g., access entries, links, etc.) to facilitate the user to further view the relevant content. In some embodiments, the reply message may include at least a portion of a set of links associated with the reply message. For example, the reply message may include link(s) to one or more documents mentioned in the reply message. In the example of FIG. 4A, the reply message 412 includes links to the document “Design Exploration,” “Design Summary,” “Design Thoughts” as mentioned. In this way, the user can conveniently access the relevant content.

Alternatively or additionally, in some embodiments, the reply message may include an access entry to the contact associated with the reply message. Though the access entry, information of the contact may be viewed or a chat with the contact may be initiated. For example, the reply message may refer to contacts of the user 140, and thus may include the access entry to these contacts. In the example of FIG. 4A, the reply message 412 includes access entries to authors of the documents mentioned. In this way, the user can conveniently communicate when needed.

Alternatively or additionally, in some embodiments, the reply message may include the access entry to a group associated with the reply message. Through the access entry, the user may navigate to the chat interface of the group. For example, the reply message may mention a group to which the user belongs, so that the access entry for the group may be included in the reply message. In this way, the user can conveniently communicate when needed.

The reply message may be presented in various suitable styles. In some embodiments, at least a portion of the reply message may be presented in a card style. For example, in the message 412 shown in FIG. 4A, for another example in the example of FIG. 4B, the document “ABCD Research” generated by the digital assistant is presented in the card style.

In some embodiments, the reply message may be generated and presented in a streaming manner. That is, the reply message may be presented incrementally as the reply content is generated. Taking the reply message 412 in FIG. 4A as an example, the reply message 412 may be presented progressively from top to bottom. With this streaming generation and presentation method, the user can read the portion already generated without waiting for extended period. In particular, when the content of the reply message is relatively large, this approach can beneficially enhance the user experience.

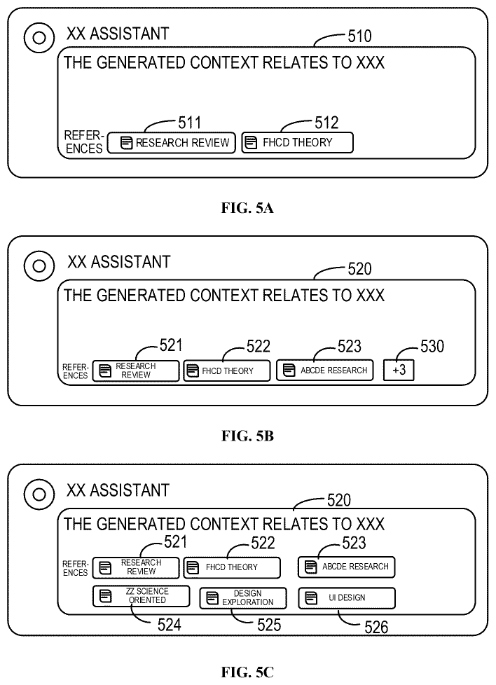

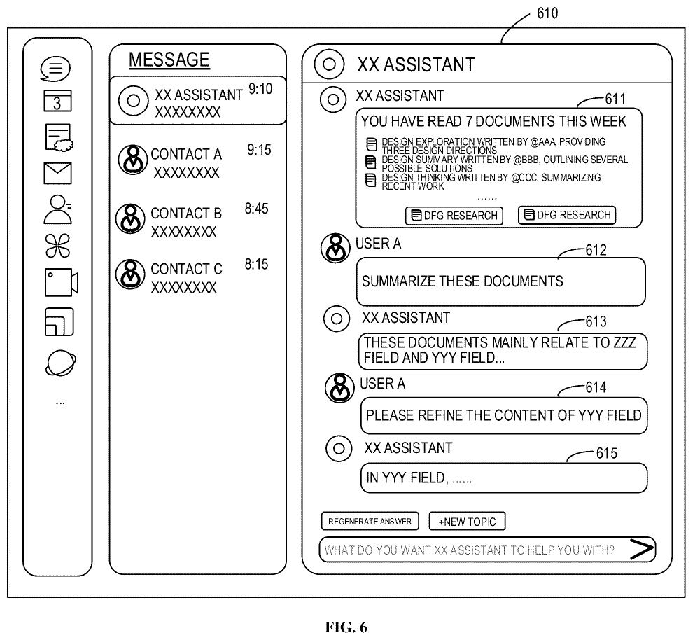

In some embodiments, the reply message may include a link to the referenced information, further referred to as a reference link. For example, the reference link may be a link of a document, a web page, or the like referenced by the digital assistant when generating the reply message. At least a portion of the reference link may be presented along with a reply message. For example, at least a portion of the reference link may be presented along with the reply message by default. In this case, at least a portion of the reference link is presented as the reply message is presented, without requiring additional operations from the user 140. In the example of FIG. 4A, the reply message 412 includes the link 413 and the link 414 to the referenced document. The link 413 and the link 414 are presented simultaneously with reply message 412. FIG. 5A shows another example of a reply message. As shown in FIG. 5A, reply message 520 includes the reference link 511 and the reference link 512.

Link 511 and link 512 are presented simultaneously with the reply message 520. The current user can access the reference link without additional operations.

In some embodiments, if there is a large amount of referenced content, a certain number (e.g., one line) of reference links may be displayed by default, and an expansion control is provided to allow the user 140 to view the remaining reference links. If the user wants to access more reference information, the expansion control may be triggered to enable the terminal device 110 to display more reference links. Referring to FIGS. 5B and 5C for an example of this. As shown in FIG. 5B, the reference links 521, 522, and 523 are displayed in reply message 520, with the expansion control 530. The number marked on the expansion control 530 indicates the number of reference links to be displayed. In response to a trigger on the expand control 530, more reference links are presented. As shown in FIG. 5C, reference links 524, 525, and 526 are further presented.

The generation of the reply message may be based on the context of the dialog between the user 140 and the digital assistant. In some embodiments, the interaction between the user 140 and the digital assistant about the same topic may include a multi-round of dialogs. In such embodiments, to generate a reply message for the current input message, the digital assistant may use the current input message context along with the previous input message.

One example is described with reference to FIG. 6. As shown in FIG. 6, a plurality of rounds of chat messages are displayed in the chat window 610. For reply message 611 output by the digital assistant, an input message 612 is received for the current user (“User A”). The digital assistant generates the reply message 613 by using the input message 612 and the user input message preceding the input message 612 as a context. subsequently, the input message 614 of the current user is received. In this example, the input message 614 references content in the reply message 613 (i.e., the YYY field). The digital assistant generates the reply message 615 by using the input message 614 and the user input message (e.g., the input message 612) preceding to the input message 614 as context. Through the multi-round dialogue, more accurate information can be provided to the user.

In some embodiments, the user may actively initiate a new topic. A control for starting a new topic may be presented. In response to receiving the trigger on the control to start a new topic, the previous topic may be ended, while the new topic may be initiated. It should be understood that if there is a reply for the previous topic that is still being generated, the generation of the reply will be terminated. Subsequently, during the process of generating the reply message for the new topic, the digital assistant will no longer takes the user input message from the previous topic as the context. It should be understood, however, that in some embodiments, the digital assistant may use user input messages and reply messages from the previous topic as historical interaction information.

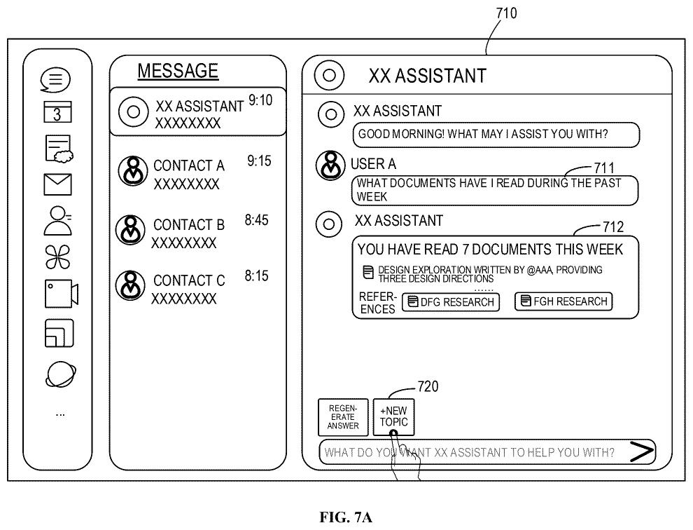

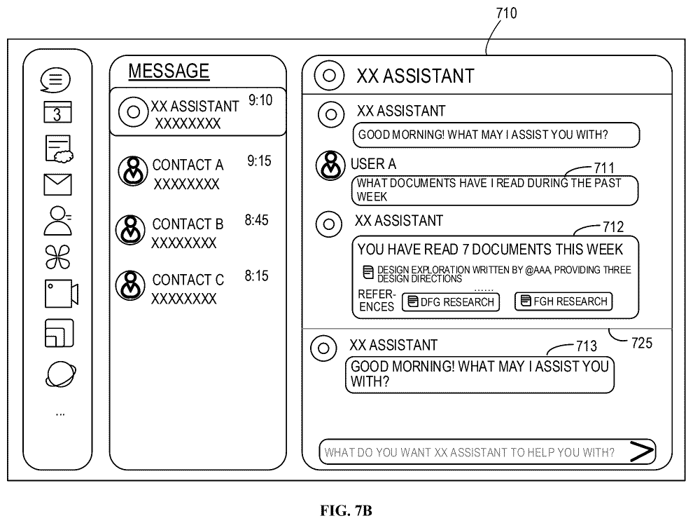

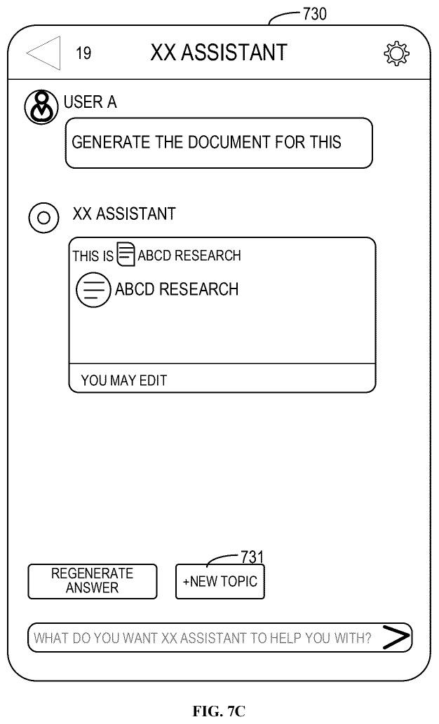

FIG. 7A illustrates an example chat window 710. In the chat window 710, the input message 711 of the current user (“User A”) and the reply message 712 of the digital assistant are displayed. In the chat window 710, a new topic control 720 is further displayed. If the current user clicks on the new topic control 720, the topic involved in the input message 711 and the reply message 712 is considered ended. During the subsequent process of reply generation, the digital assistant no longer takes the input message 711 as context.

Accordingly, in response to the start new topic control 720 being clicked, the chat window 710 changes to the state as shown in FIG. 7B. For example, in the chat window 710, the start new topic control 720 is no longer displayed. In addition, in the chat window 710, a new and old topic separator 725 and a prompt message 713 from the digital assistant is displayed.

FIG. 7C illustrates another example chat window 730. The chat windows 720 and 730 may be viewed as example implementations of chat windows on different types of devices. As shown in FIG. 7C, in the chat window 730, a start new topic control 731 is displayed. Similar to the examples shown in FIGS. 7A and 7B, the new topic may be actively initiated by the user by triggering an operation on the start new topic control 731.

In some embodiments, the next operation of the digital assistant may be recommended to the user 140. For example, a recommendation control may be presented in the chat window indicating the next operation of the digital assistant. The recommended next operation may be determined based on the current dialog between the user 140 and the digital assistant. The user 140 may conveniently and quickly provide the next instruction to the digital assistant by clicking on the recommendation control. In this way, the interaction efficiency between the user and the digital assistant can be improved, thereby enhancing the user experience.

In some embodiments, the user 140 may evaluate or provide feedback to the reply message of the digital assistant. For example, multiple evaluation options for a reply message for a digital assistant may be presented in a chat window. Subsequently, the selection of the plurality of evaluation options by the user 140 may be received via the chat window. The plurality of evaluation options may include positive evaluation, negative evaluation, neutral evaluation, and the like. For example, a “Like” option, a “Dislike” option, and a “No Opinion” option may be presented. As another example, a “Helpful” option, a “Not helpful” option, etc. may be presented.

In some embodiments, if the user 140 selects a negative evaluation option, further feedback from the user 140 regarding on the negative feedback may be requested. For example, a form may be presented. In a form, the user may input text to provide the reason for a negative evaluation. Alternatively or additionally, a reason option maybe presented for user to select from, including, but not limited to, “Information in not accurate,” “information is not helpful to me,” or the like. In some embodiments, text input may be unnecessary, a reason option may be necessary. If the user 140 selects a positive evaluation option, the user 140 may not be required to provide further feedback. For example, a form may not be popped.

The evaluation of the reply message by the user 140 may be stored as part of historical interaction information between the user 140 and the digital assistant. In some embodiments, the historical interaction information between the user 140 with the digital assistant includes the evaluation of the user 140. For example, the evaluation of the reply message by the user 140 may be stored as historical interaction information.

In some embodiments, the user 140 may actively terminate the generation of the reply. For example, in response to receiving an input message from user 140, state information may be presented in the chat window indicating that the digital assistant is performing the processing based on the input message. If a predetermined operation of the user 140 is received, the state information may be stopped. After the user 140 actively terminates the generation, the content that has been generated may continue to be presented and stored as historical interaction information. The content that has not been generated will no longer be generated.

The predetermined operation may include various suitable operations. The predetermined operation may include a trigger on a terminate reply control. For example, the terminate reply control may be displayed in the chat window while the state information is presented. If the user 140 clicks the terminate reply control, the presentation state information is stopped. That is, generating a reply is stopped.

Alternatively or additionally, the predetermined operation may include a trigger to start new topic control. For example, a start new topic control may be displayed in the chat window while the state information is being presented. If the user 140 clicks on the start new topic control, the presentation of the state information is stopped.

Alternatively or additionally, the predetermined operation may include an operation of inputting a message in an input box and sending in the chat window. For example, while the state information is being presented, the user 140 may inputs information in an input box and sends in the chat window. In response to this, the presentation state information is stopped, and reply content is generated based on the latest message sent by the user, combined with the context.

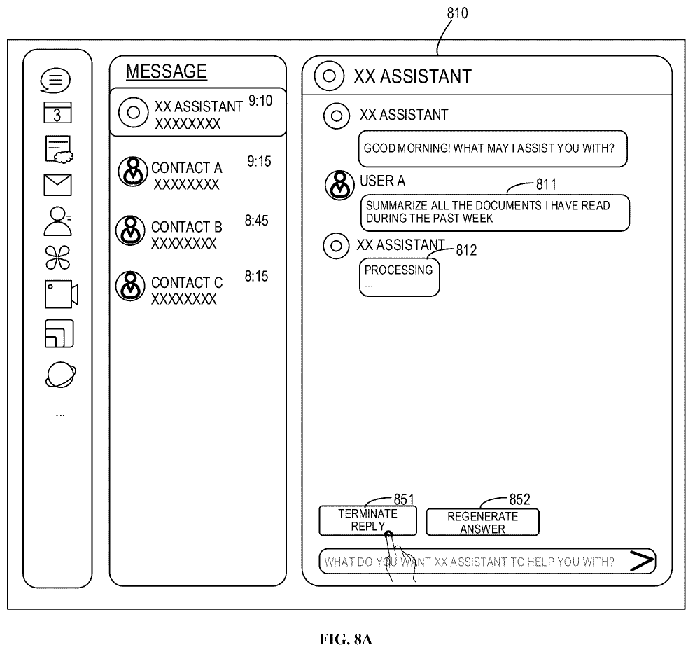

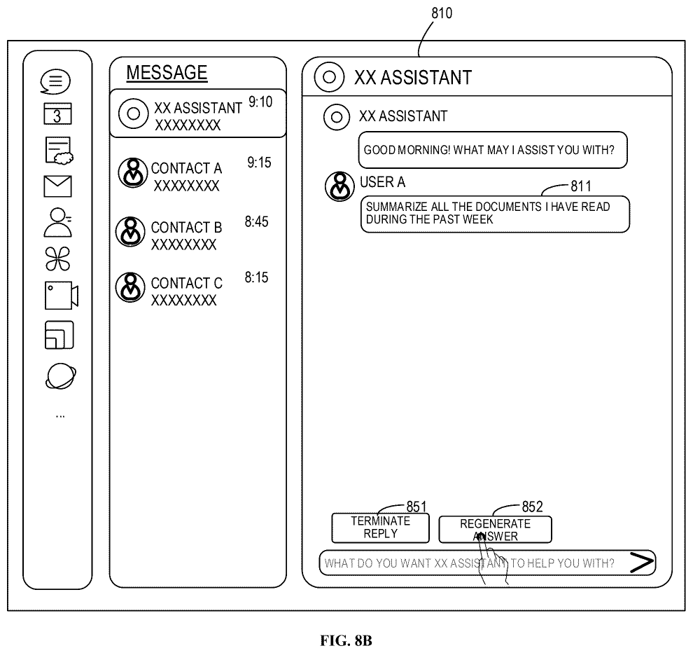

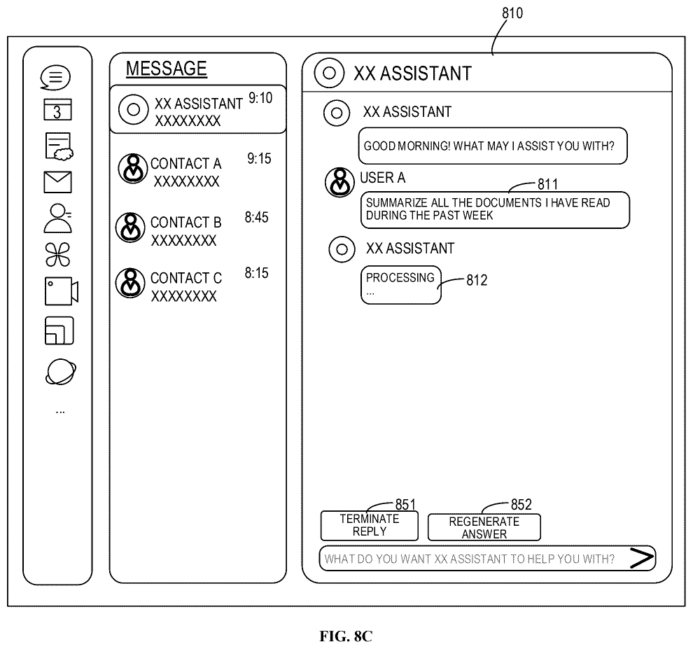

In some embodiments, when the state information presentation is stopped, if a trigger on the regenerate answer control is received, the state information may be presented again in the chat window. That is, the digital assistant resumes generating the reply message for the input message. Such an example is described with reference to FIGS. 8A-8C. As shown in FIG. 8A, the input message 811 and the state information 812 of the current user (“User A”) are displayed in the chat window 810. The state information 812 indicates that the digital assistant is processing based on the input message 811.

A terminate reply control 851 and a regenerate answer control 852 are further displayed in the chat window 810. In response to the current user clicking on the terminate reply control 851, the presented chat window 810 changes to as shown in FIG. 8B. As shown in FIG. 8B, the presentation state information 812 is stopped. Accordingly, the digital assistant may terminate generating the reply for the input message 811.

If the current user clicks on the regenerate answer control 852, the presented chat window 810 changes to as shown in FIG. 8C. As shown in FIG. 8C, the state information 812 is again presented. Accordingly, the digital assistant may resume generating a reply for the input message 811.

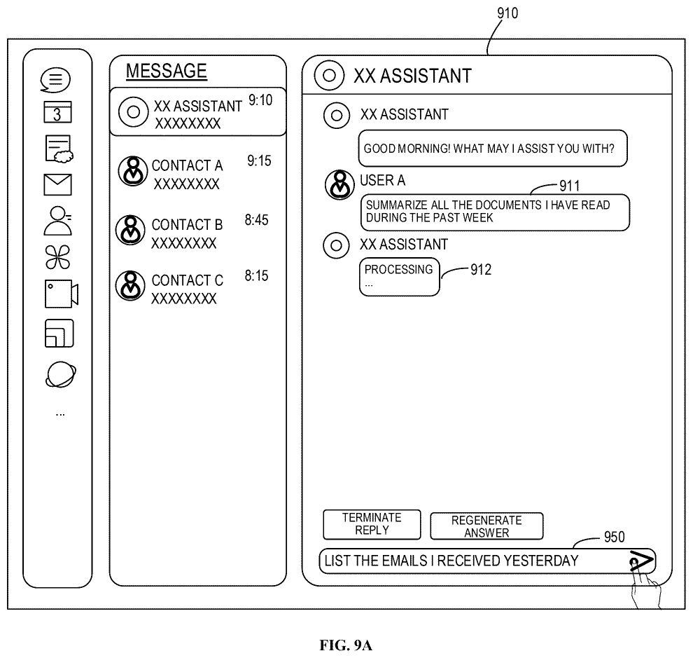

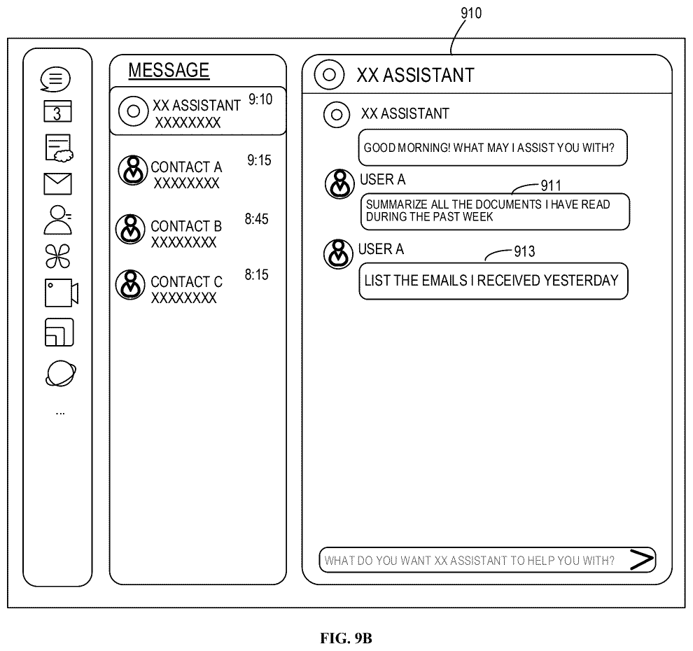

In some embodiments, if the state information presentation is stopped and a further input message from the user 140 is received, the digital assistant may use the previous input message and the further input message as a context to generate a reply message. The reply message may then be presented in a chat window. Refer to FIGS. 9A-9C for an example of this. As shown in FIG. 9A, the input message 911 and the state information 912 of the current user (“User A”) are displayed in the chat window 910. The state information 912 indicates that the digital assistant is performing the processing based on the input message 911.

An input box 915 is further displayed in the chat window 910. The current user inputs a message “List all the emails I received yesterday” in input box 915 and sends. In response to this predetermined operation, the presented chat window 910 changes to as shown in FIG. 9B. As shown in FIG. 9B, the presentation state information 912 is stopped. Accordingly, the digital assistant may terminate generating a reply to the input message 911. Further, an input message 913 for the current user is displayed in the chat window 910. The presented chat window 910 then changes to as shown in FIG. 9C. As shown in FIG. 9C, the state information 914 is presented to indicate that the digital assistant is performing the processing based on the input messages 911 and 913.

With reference to the accompanying drawings, the abovementioned description illustrates example interfaces for setting and interacting with a digital assistant. It should be understood that the various interfaces described above and the interface elements, text and the like therein are only for the purpose of illustration and are not intended to limit the scope of the present disclosure. Further, it should be understood that the various embodiments described above may be implemented separately or in combination.

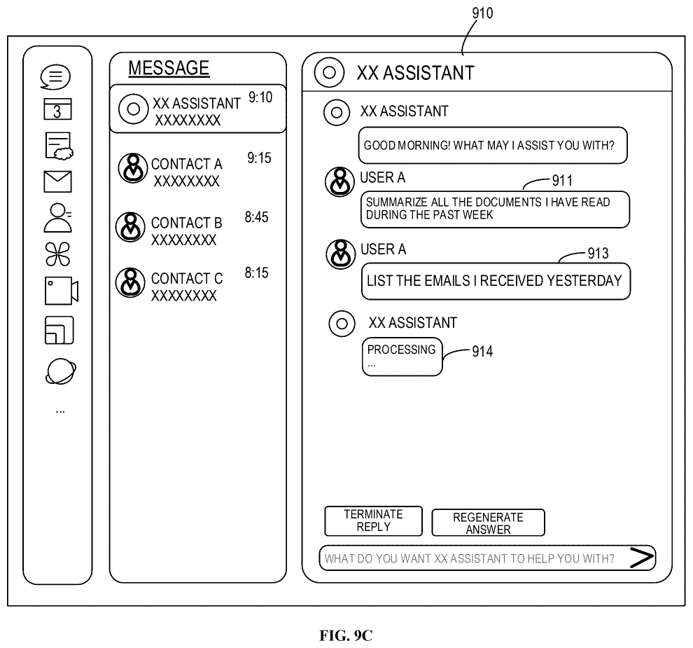

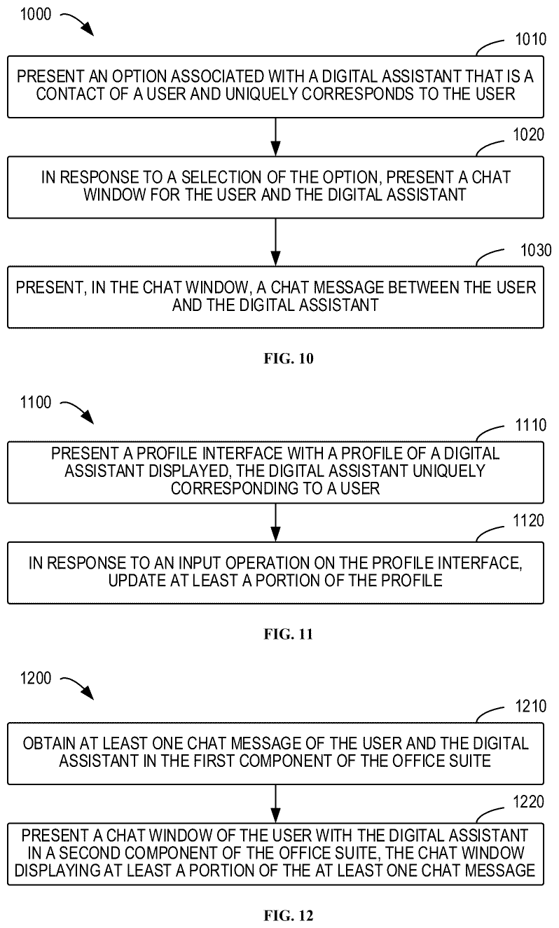

FIG. 10 illustrates a flowchart of a method 1000 for information processing according to some embodiments of the present disclosure. The method 1000 may be implemented at the terminal device 110. The method 1000 is described below with reference to FIG. 1.

At block 1010, the terminal device 110 presents an option associated with a digital assistant that is a contact of a user and uniquely corresponds to the user.

At block 1020, the terminal device 110 presents a chat window for the user and the digital assistant in response to a selection of the option.

At block 1030, the terminal device 110 presents a chat message between the user and the digital assistant in the chat window.

In some embodiments, presenting the chat message between the user and the digital assistant in the chat window includes: in response to receiving a first input message from the user, presenting state information in the chat window, the state information indicating that the digital assistant is processing based on the first input message; and in response to receiving a predetermined operation from the user, terminating presenting the state information.

In some embodiments, the predetermined operation includes: a trigger on a terminate reply control, a trigger on a start new topic control, or inputting a message in an input box in the chat window and sending the message.

In some embodiments, the method 1000 further includes: in response to a trigger on a regenerate answer control, presenting the state information again in the chat window.

In some embodiments, the method 1000 further includes in response to receiving a second input message from the user, presenting a reply message generated using at least the first input message and the second input message as a context.

In some embodiments, presenting the option includes presenting, in a contact interface, a contact option corresponding to the digital assistant.

In some embodiments, presenting, in the chat window, the chat message between the user and the digital assistant includes: receiving a third input message from the user via the chat window; and presenting, in the chat window, a first reply message generated by the digital assistant for the third input message, wherein at least a portion of the first reply message is presented in a card style, or the first reply message includes at least a portion of a set of links associated with the first reply message, or the first reply message includes an access entry of a contact associated with the first reply message, or the first reply message includes an access entry of a group associated with the first reply message.

In some embodiments, the method 1000 further includes receiving a fourth input message from the user via the chat window; and presenting a second reply message in the chat window; wherein the second reply message is generated by the digital assistant using at least one user input message preceding the fourth input message and the fourth input message as a context.

In some embodiments, the method 1000 further includes: in response to receiving a trigger on a new topic starting control, receiving a fifth input message from the user via the chat window; and presenting a third reply message in the chat window; wherein the third reply message is generated by the digital assistant based on the fifth input message without using a user input message preceding the fifth input message as a context.

In some embodiments, a language of a reply message output by the digital assistant in the chat window is determined based on at least one of: a language specified by the user, a language of a message input by the user, a language of a content referenced by the reply message output by the digital assistant, or a system language of a component presenting the chat window.

In some embodiments, a reply message output by the digital assistant in the chat window includes a link to information referenced by the reply message, and at least a portion of the link is presented with the reply message.

In some embodiments, the method 1000 further includes presenting, in the chat window, a comment option for a reply message of the digital assistant; and receiving, via the chat window, a selection of the comment option by the user, and wherein historical interaction information for the user and the digital assistant includes the selection of the comment option by the user.

In some embodiments, the options associated with the digital assistant is presented in an office suite.

In some embodiments, the method 1000 further includes in response to an input operation on the profile interface, updating at least a portion of the profile.

In some embodiments, at least a portion of the profile includes at least one of the following: an avatar representing the digital assistant, a name for remarking the digital assistant, or description information of the digital assistant.

In some embodiments, the method 1000 further includes in response to a trigger on a link in the profile interface, presenting illustration information for the digital assistant.

In some embodiments, the method 1000 further includes: in response to a trigger on a setting control of the digital assistant, presenting a permission setting interface for the digital assistant; and receiving, via the permission setting interface, a user input setting a data range allowed to be accessed by the digital assistant.

In some embodiments, the digital assistant is dedicated to the user and the data range includes a data range of the user that allows the digital assistant to access.

In some embodiments, the digital assistant is configured to reply to an input message by the user or perform an operation related to the input message based on at least one of: historical interaction information for the user and the digital assistant in a plurality of components, or the data range allowed to be accessed by the digital assistant, or the input message.

In some embodiments, historical interaction information for the user and the digital assistant in the plurality of components is stored in association with the user.

In some embodiments, in any of the plurality of components, the digital assistant is invoked by a predetermined mode corresponding to the component to receive an instruction input by the user.

FIG. 11 shows a flowchart of a method 1100 for information processing according to some embodiments of the present disclosure. The method 1100 may be implemented at the terminal device 110. The method 1100 is described below with reference to FIG. 1.

At block 1110, the terminal device 110 presents a profile interface displaying a profile of the digital assistant that uniquely corresponds to the user.

At block 1120, the terminal device 110 updates at least a portion of the profile in response to an input operation to the profile interface.

In some embodiments, the at least a portion of the profile includes at least one of: an avatar representing the digital assistant, a name for remarking the digital assistant, or description information for the digital assistant.

In some embodiments, the method 1100 further includes presenting the illustration information for the digital assistant in response to a triggering operation on a link in the profile interface.

In some embodiments, the method 1100 further includes: in response to a trigger on a setting control of the digital assistant, presenting a permission setting interface for the digital assistant; and receiving, via the permission setting interface, a user input setting a data range allowed to be accessed by the digital assistant.

In some embodiments, the digital assistant is dedicated to the user and the data range includes a data range of the user that allows the digital assistant to access.

In some embodiments, the digital assistant is configured to reply to an input message by the user or perform an operation related to the input message based on at least one of: historical interaction information for the user and the digital assistant in a plurality of components, or the data range allowed to be accessed by the digital assistant, or the input message.

In some embodiments, historical interaction information for the user and the digital assistant in the plurality of components is stored in association with the user.

In some embodiments, in any of the plurality of components, the digital assistant is invoked by a predetermined mode corresponding to the component to receive an instruction input by the user.

In some embodiments, the method 1100 includes presenting a permission setting interface associated with a digital assistant; receiving, via the permission setting interface, a user input comprising data range information allowed to be accessed by the digital assistant; receiving first information via an input interface associated with the digital assistant; and displaying second information generated at least based on the first information and data indicated by the data range information.

In some embodiments, the method 1100 further includes presenting a profile interface with a profile of the digital assistant; in response to an input operation on the profile interface, updating at least a portion of the profile, wherein the at least a portion of the profile comprises at least one of: an avatar representing the digital assistant, a name for remarking the digital assistant, or description information of the digital assistant.

In some embodiments, a data range allowed to be access by the digital assistant comprises at least one of the following: a document, a calendar, a mailbox, or at least one email related to a topic.

In some embodiments, the method 1100 further includes in response to a trigger on a link in a profile interface with a profile of the digital assistant, presenting illustration information for the digital assistant.

In some embodiments, the digital assistant is configured to reply to an input message by a user or perform an operation related to the input message based on at least one of: historical interaction information for the user and the digital assistant in a plurality of components, or data range allowed to be accessed by the digital assistant, or the input message.

In some embodiments, the historical interaction information for the user and the digital assistant in the plurality of components is stored in association with the user.

In some embodiments, in a component of the plurality of components, the digital assistant is invoked by a predetermined mode corresponding to the component to receive an instruction input by the user.

FIG. 12 shows a flowchart of a method 1200 for information processing according to some embodiments of the present disclosure. Process 1200 may be implemented by a suitable electronic device or combination of electronic devices (e.g., server 130, terminal device 110, or a combination of server 130 and terminal device 110 in FIG. 1). Process 1200 will be described below with terminal device 110 as an example.

At block 1210, the terminal device 110 obtains at least one chat message between the user 140 and the digital assistant in the first component of the office suite 120.

As discussed in the abovementioned description, an office suite may include a number of components (further referred to as office components), examples of which may include, but are not limited to, a chat component, a document component, an audio/video conference component, a mail component, a calendar component, a schedule component, a task component, an OKR component, and/or any suitable office component currently existing or possibly developed in the future.

Further, the terminal device 110 may obtain at least one chat message between the user 140 and the digital assistant in a specific component. For example, the user 140 may interact with the digital assistant in a document component of the office suite and generate at least one chat message.

At block 1220, the terminal device 110 presents a chat window between the user 140 and the digital assistant in a second component of the office suite, the chat window displaying at least portion of the at least one chat message.

As an illustrative example, the second component includes, for example, other components different from the first component in the office suite. For example, the user 140 may further interact with the digital assistant in the mail component and present the chat window accordingly.

Correspondingly, the terminal device 110 may further present, in a chat window of the second component (for example, a mail component), a portion of at least one chat message in the first component (for example, a document component).

As another example, the second component may be, for example, a chat component. For example, the terminal device 110 may present only a portion of at least one chat message from other components in a chat window of the chat component. In other office components (for example, a mail component), the terminal device 110 may only present a historical interaction message in the office component.

By providing a portion of at least one chat message of other components in a chat window of a chat component, embodiments of the present disclosure may provide a unified global message for a user, thereby facilitating user perception or inquiry of historical interaction behavior with the digital assistant.

In some embodiments, the terminal device 110 may display the aggregated message corresponding to the at least one chat message in the chat window. For example, in case where multi-rounds of dialogue occur between the user and the digital assistant in the document component, the terminal device 110 may present the aggregated message corresponding to the multi-rounds of dialogue in the chat window, thereby improving the efficiency of information display in the window and reducing interference with the current interactions of a user.

In some embodiments, the terminal device 110 may receive a selection of the aggregated message, and correspondingly present the entire content of the at least one chat message. Thus, the embodiments of the present disclosure can provide a complete chat message to a user if the user wishes to view a chat message with the digital assistant in other components.

In some embodiments, the server 120 receives the selection of the aggregated message, and the terminal device 110 presents the entire content of the at least one chat message. The presentation manner includes, but is not limited to, presenting a full text of each chat message or presenting only a preamble portion of each chat message, and so on. For example, when the user selects the aggregated message, the plurality of chat messages included therein may be sequentially expanded or only the first chat message is expanded. When the user further selects another chat message, the chat message is presented in a targeted manner and the unfolded chat message is folded.

In some embodiments, at least a portion of the at least one chat message is presented in the chat window as a card style. For example, the terminal device 110 may, for example, provide a card corresponding to the at least one chat message. Such cards may, for example, be interactive as a whole card, which may be forwarded, deleted, moved, copied to other locations, and the like.

In some embodiments, the server 120 may obtain, for example, at least one chat message corresponding to a historical interaction event as a granularity. For example, the server 120 obtains at least one chat message corresponding to a historical interaction event between the user 140 and the digital assistant in the first component.

In some embodiments, such historical interaction events include at least one round of dialog interaction between a user and a digital assistant. For example, whether the multi-rounds dialogue interaction belongs to the same historical interaction event may be determined based on the interval time between the at least one round of dialogue interaction. For example, two rounds of dialogue interaction with an interval time exceeding a threshold time may be determined as not belonging to the same historical interaction event.

Therefore, the embodiments of the disclosure can determine corresponding historical interaction events based on the aggregation of the dialogue interaction, present at least one conversation message corresponding to the historical interaction events in the conversation interface with the digital assistant accordingly.

In some embodiments, historical chat messages corresponding to at least one round of dialogue interaction within a single historical interaction event are presented as aggregated messages in the chat interface. For example, different rounds of dialogue interaction corresponding to different historical interaction events can be presented as different aggregated messages in the chat interface.

The aggregated message may specifically adopt the form of a topic message or other possible message thread formats, which are not limited herein.

Based on the abovementioned discussion, the embodiments of the present disclosure enable users to perceive a global interaction process with a digital assistant in an office suite, thereby enhancing user interaction experience. In addition, this can also assist in perceiving the user global interaction process with the office suite.

It should be understood that one or more of the steps, features, characteristics, or combinations thereof described with reference to the above example information processing process may further be suitably incorporated into the process without departing from the subject matter of the process 1200. This is not repeated herein.

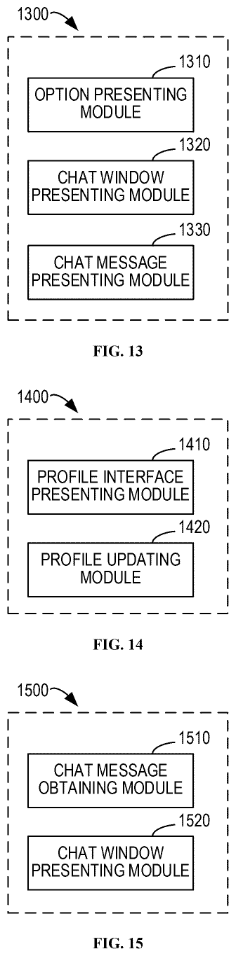

FIG. 13 is a schematic structural block diagram of an information processing apparatus 1300 according to some embodiments of the present disclosure. The apparatus 1300 may be implemented or included in the terminal device 110. The various modules/components in the apparatus 1300 may be implemented by hardware, software, firmware, or any combination thereof.

As shown, the apparatus 1300 includes an option presenting module configured to present an option associated with a digital assistant that is a contact of a user and uniquely corresponds to the user. The apparatus 1300 further includes a chat window presenting module configured to in response to a selection of the option, present a chat window for the user and the digital assistant. The apparatus 1300 further includes a chat message presenting module configured to present, in the chat window, a chat message between the user and the digital assistant.

In some embodiments, the chat message presentation module 1330 is further configured to: in response to receiving a first input message from the user, present state information in the chat window, the state information indicating that the digital assistant is processing based on the first input message; and in response to receiving a predetermined operation from the user, terminate presenting the state information.

In some embodiments, the predetermined operation includes: a trigger on a terminate reply control, a trigger on a start new topic control, or inputting a message in an input box in the chat window and sending the message.

In some embodiments, the chat window presenting module 1320 is further configured to present state information again in the chat window in response to a triggering operation on the replying control.

In some embodiments, the chat message presentation module 1330 is further configured to in response to receiving a second input message from the user, present a reply message generated using at least the first input message and the second input message as a context.

In some embodiments, the option presentation module 1310 is further configured to present, in a contact interface, a contact option corresponding to the digital assistant.

In some embodiments, the chat message presentation module 1330 is further configured to: receive, a third input message from the user via the chat window; and present, in the chat window, a first reply message generated by the digital assistant for the third input message, wherein at least a portion of the first reply message is presented in a card style, or the first reply message includes at least a portion of a set of links associated with the first reply message, or the first reply message includes an access entry of a contact associated with the first reply message, or the first reply message includes an access entry of a group associated with the first reply message.

In some embodiments, the chat message presentation module 1330 is further configured to: receive, a fourth input message from the user via the chat window; and present, a second reply message in the chat window; wherein the second reply message is generated by the digital assistant using at least one user input message preceding the fourth input message and the fourth input message as a context.

In some embodiments, the chat message presentation module 1330 is further configured to: in response to receiving a trigger on a new topic starting control, receive a fifth input message from the user via the chat window; and present, a third reply message in the chat window; wherein the third reply message is generated by the digital assistant based on the fifth input message without using a user input message preceding the fifth input message as a context.

In some embodiments, a language of a reply message output by the digital assistant in the chat window is determined based on at least one of: a language specified by the user, a language of a message input by the user, a language of a content referenced by the reply message output by the digital assistant, or a system language of a component presenting the chat window.

In some embodiments, a reply message output by the digital assistant in the chat window includes a link to information referenced by the reply message, and at least a portion of the link is presented with the reply message.

In some embodiments, the chat message presentation module 1330 is further configured to: present, in the chat window, a comment option for a reply message of the digital assistant; and receive, via the chat window, a selection of the comment option by the user, and wherein historical interaction information for the user and the digital assistant includes the selection of the comment option by the user.

In some embodiments, the options associated with the digital assistant is presented in an office suite.

In some embodiments, the apparatus 1300 further includes a profile updating module configured to update at least a portion of the profile in response to an input operation to the profile interface.

In some embodiments, at least a portion of the profile includes at least one of the following: an avatar representing the digital assistant, a name for remarking the digital assistant, or description information of the digital assistant.

In some embodiments, the apparatus 1300 further includes: a description information presenting module configured to present description information for the digital assistant in response to a triggering operation on a link in the profile interface.

In some embodiments, the profile updating module is further configured to: in response to a trigger on a setting control of the digital assistant, present a permission setting interface for the digital assistant; and receive, via the permission setting interface, a user input setting a data range allowed to be accessed by the digital assistant.

In some embodiments, the digital assistant is dedicated to the user, and the data range includes a data range of the user that allows the digital assistant to access.

In some embodiments, the digital assistant is configured to reply to an input message by the user or perform an operation related to the input message based on at least one of: historical interaction information for the user and the digital assistant in a plurality of components, or the data range allowed to be accessed by the digital assistant, or the input message.

In some embodiments, historical interaction information for the user and the digital assistant in the plurality of components is stored in association with the user.

In some embodiments, in any of the plurality of components, the digital assistant is invoked by a predetermined mode corresponding to the component to receive an instruction input by the user.

FIG. 14 is a schematic structural block diagram of an information processing apparatus 1400 according to some embodiments of the present disclosure. The apparatus 1400 may be implemented or included in the terminal device 110. The various modules/components in the apparatus 1400 may be implemented by hardware, software, firmware, or any combination thereof.

As shown, the device 1400 includes a profile interface presentation module 1410 configured to present a profile interface displaying a profile of a digital assistant that uniquely corresponds to a user. The apparatus 1400 further includes a profile updating module 1420 configured to update at least a portion of the profile in response to an input operation to the profile interface.

In some embodiments, at least a portion of the profile includes at least one of the following: an avatar representing the digital assistant, a name for remarking the digital assistant, or description information for the digital assistant.

In some embodiments, the apparatus 1400 further includes: a description information presenting module configured to present description information for the digital assistant in response to a triggering operation on a link in the profile interface.

In some embodiments, the profile updating module 1420 is further configured to: in response to a trigger on a setting control of the digital assistant, present a permission setting interface for the digital assistant; and receive, via the permission setting interface, a user input setting a data range allowed to be accessed by the digital assistant.

In some embodiments, the digital assistant is dedicated to the user, and the data range includes a data range of the user that allows the digital assistant to access.

In some embodiments, the digital assistant is configured to reply to an input message by the user or perform an operation related to the input message based on at least one of: historical interaction information for the user and the digital assistant in a plurality of components, or the data range allowed to be accessed by the digital assistant, or the input message.

In some embodiments, historical interaction information for the user and the digital assistant in the plurality of components is stored in association with the user.

In some embodiments, in any of the plurality of components, the digital assistant is invoked by a predetermined mode corresponding to the component to receive an instruction input by the user.

FIG. 15 is a schematic structural block diagram of an information processing apparatus 1500 according to some embodiments of the present disclosure. The apparatus 1500 may be implemented or included in the terminal device 110. The various modules/components in the apparatus 1500 may be implemented by hardware, software, firmware, or any combination thereof.

As shown, the apparatus 1500 includes a chat message obtaining module 1510, configured to obtain at least one chat message of a user and a digital assistant in a first component of an office suite. The apparatus 1500 further includes a chat window presentation module 1520 configured to present a chat window of the user with the digital assistant in a second component of the office suite, the chat window displaying at least part of the at least one chat message.

In some embodiments, the second component includes a chat component of the office suite.

In some embodiments, the apparatus 1500 further includes a receiving module configured to receive a selection of the aggregated message; and a presenting module configured to present an entire content of the at least one chat message.

In some embodiments, at least a portion of the at least one chat message is presented in the chat window as a card style.

In some embodiments, the chat message obtaining module 1510 is configured to obtain at least one chat message corresponding to a historical interaction event between the user and the digital assistant in the first component.

In some embodiments, the historical interaction event includes at least one round of dialog interaction between the user and the digital assistant.

In some embodiments, the historical chat message corresponding to the at least one round of dialog interaction is presented as an aggregated message in the chat window.

In some embodiments, the user includes an individual user and/or an organizational user.

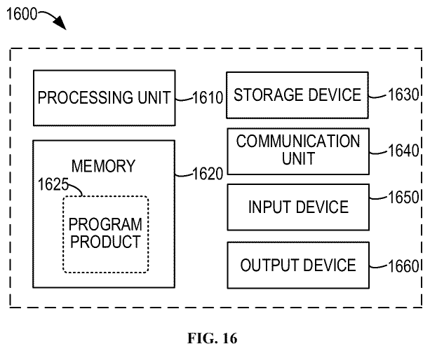

FIG. 16 illustrates a block diagram of an electronic device 1600 in which one or more embodiments of the present disclosure may be implemented. It should be understood that the electronic device 1600 shown in FIG. 16 is merely an example and should not constitute any limitation on the functionality and scope of the embodiments described herein. The electronic device 1600 shown in FIG. 16 may be used to implement the electronic device of FIG. 1.

As shown in FIG. 16, the electronic device 1600 is in the form of a general-purpose electronic device. Components of the electronic device 1600 may include, but are not limited to, one or more processors or processing units 1610, a memory 1620, a storage device 1630, one or more communication units 1640, one or more input devices 1650, and one or more output devices 1660. The processing unit 1610 may be an actual or virtual processor and capable of performing various processes according to programs stored in the memory 1620. In multiprocessor systems, multiple processing units execute computer executable instructions in parallel to improve the parallel processing capability of electronic device 1600.

The electronic device 1600 typically includes a plurality of computer storage media. Such media may be any available media accessible by the electronic device 1600, including, but not limited to, volatile and non-volatile media, removable and non-removable media. The memory 1620 may be a volatile memory (e.g., a register, a cache, a random-access memory (RAM)), a non-volatile memory (e.g., read-only memory (ROM), an electrically erasable programmable read-only memory (EEPROM), flash memory), or some combination thereof. A storage device 1630 may be a removable or non-removable medium and may include a machine-readable medium, such as a flash drive, a magnetic disk, or any other medium, which may be used to store information and/or data and may be accessed within the electronic device 1600.

The electronic device 1600 may further include additional removable/non-removable, volatile/non-volatile storage media. Although not shown in FIG. 16, a disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 1620 may include a computer program product 1625 having one or more program modules configured to perform various methods or actions of various embodiments of the present disclosure.

The communications unit 1640 implements communications with other electronic devices over a communications medium. Additionally, the functionality of components of the electronic device 1600 may be implemented in a single computing cluster or a plurality of computing machines capable of communicating over a communication connection. Thus, the electronic device 1600 may operate in a networked environment using logical connections to one or more other servers, network personal computers (PCs), or another network node.

The input device 1650 may be one or more input devices such as a mouse, a keyboard, a trackball, or the like. The output device 1660 may be one or more output devices, such as a display, a speaker, a printer, or the like. The electronic device 1600 may further communicate with one or more external devices (not shown) such as a storage device, a display device, or the like through the communication unit 1640 as required, and communicate with one or more devices that enable a user to interact with the electronic device 1600, or communicate with any device (e. g., a network card, a modem, or the like) that enables the electronic device 1600 to communicate with one or more other electronic devices. Such communication may be performed via an input/output (I/O) interface (not shown).

According to example implementations of the present disclosure, there is provided a computer readable storage medium having computer instructions stored thereon, where the computer instructions are executed by a processor to implement the method described above. According to example implementations of the present disclosure, there is further provided a computer program product, and the computer program product is tangibly stored on a non-transitory computer readable medium and includes computer executable instructions, and the computer executable instructions are executed by the processor to implement the above-described method.

Aspects of the present disclosure are described herein with reference to flowcharts and/or block diagrams of methods, apparatuses, devices and computer program products implemented according to the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may further be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may further be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods, and computer program products according to various implementations of the present disclosure. In this regard, each block in the flowchart or block diagram may represent a module, segment, or portion of instructions which includes one or more executable instructions for implementing the specified logical function(s). In some replaced implementations, the functions marked in the blocks may occur in a different order than those marked in the drawings. For example, two consecutive blocks may actually be executed in parallel, or they may sometimes be executed in reverse order, depending on the function involved. It should further be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the present disclosure have been described as above, the foregoing description is illustrative, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

What is claimed is:

1. A method of information processing, comprising:
presenting an option associated with a digital assistant that is a contact of a user;
in response to a selection of the option, presenting a chat window for the user and the digital assistant; and
presenting, in the chat window, a chat message between the user and the digital assistant, the presenting comprising:
receiving a third input message from the user via the chat window; and
presenting, in the chat window, a first reply message generated by the digital assistant for the third input message, wherein
at least a portion of the first reply message is presented in a card style, or
the first reply message comprises at least a portion of a set of links associated with the first reply message, or
the first reply message comprises an access entry of a contact associated with the first reply message, or
the first reply message comprises an access entry of a group associated with the first reply message.

2. The method of claim 1, wherein presenting, in the chat window, the chat message between the user and the digital assistant comprises:
in response to receiving a first input message from the user, presenting state information in the chat window, the state information indicating that the digital assistant is processing based on the first input message; and
in response to receiving a predetermined operation from the user, terminating presenting the state information.

3. The method of claim 2, wherein the predetermined operation comprises:
a trigger on a terminate reply control,
a trigger on a start new topic control, or
inputting a message in an input box in the chat window and sending the message.

4. The method of claim 2, further comprising:
in response to a trigger on a regenerate answer control, presenting the state information again in the chat window.

5. The method of claim 2, further comprising:
in response to receiving a second input message from the user, presenting a reply message generated using at least the first input message and the second input message as a context.

6. The method of claim 1, wherein presenting the option comprises:
presenting, in a contact interface, a contact option corresponding to the digital assistant, the digital assistant uniquely corresponding to the user.

7. The method of claim 1, further comprising:
receiving a fourth input message from the user via the chat window; and
presenting a second reply message in the chat window; wherein the second reply message is generated by the digital assistant using at least one user input message preceding the fourth input message and the fourth input message as a context.

8. The method of claim 1, further comprising:
in response to receiving a trigger on a new topic starting control, receiving a fifth input message from the user via the chat window; and
presenting a third reply message in the chat window; wherein the third reply message is generated by the digital assistant based on the fifth input message without using a user input message preceding the fifth input message as a context.

9. The method of claim 1, wherein a language of a reply message output by the digital assistant in the chat window is determined based on at least one of:
a language specified by the user,
a language of a message input by the user,
a language of a content referenced by the reply message output by the digital assistant, or
a system language of a component presenting the chat window.

10. The method of claim 1, wherein a reply message output by the digital assistant in the chat window comprises a link to information referenced by the reply message, and at least a portion of the link is presented with the reply message.

11. The method of claim 1, further comprising:
presenting, in the chat window, a comment option for a reply message of the digital assistant; and
receiving, via the chat window, a selection of the comment option by the user, and wherein
historical interaction information for the user and the digital assistant comprises the selection of the comment option by the user.

12. The method of claim 1, wherein the option associated with the digital assistant is presented in an office suite.

13. A method of information processing, comprising:
presenting a permission setting interface associated with a digital assistant;
receiving, via the permission setting interface, a user input comprising data range information allowed to be accessed by the digital assistant;
receiving first information via an input interface associated with the digital assistant; and
displaying second information generated at least based on the first information and data indicated by the data range information.

14. The method of claim 13, further comprising:
presenting a profile interface with a profile of the digital assistant;
in response to an input operation on the profile interface, updating at least a portion of the profile, wherein the at least a portion of the profile comprises at least one of:
an avatar representing the digital assistant,
a name for remarking the digital assistant, or
description information of the digital assistant.

15. The method of claim 13, wherein a data range allowed to be access by the digital assistant comprises at least one of the following:
a document,
a calendar,
a mailbox, or
at least one email related to a topic.

16. The method of claim 13, further comprising:
in response to a trigger on a link in a profile interface with a profile of the digital assistant, presenting illustration information for the digital assistant.

17. The method of claim 15, wherein the digital assistant is configured to reply to an input message by a user or perform an operation related to the input message based on at least one of:
historical interaction information for the user and the digital assistant in a plurality of components, or
the data range allowed to be accessed by the digital assistant, or
the input message.

18. The method of claim 17, wherein
the historical interaction information for the user and the digital assistant in the plurality of components is stored in association with the user.

19. The method of claim 18, wherein
in a component of the plurality of components, the digital assistant is invoked by a predetermined mode corresponding to the component to receive an instruction input by the user.

20. An electronic device, comprising:
at least one processor; and
at least one memory coupled to the at least one processor and storing instructions for execution by the at least one processor, the instructions, when executed by the at least one processor, causing the electronic device to perform operations comprising:
presenting a permission setting interface associated with a digital assistant;
receiving, via the permission setting interface, a user input comprising data range information allowed to be accessed by the digital assistant;
receiving first information via an input interface associated with the digital assistant; and
displaying second information generated at least based on the first information and data indicated by the data range information.
